(19) United States
(12) Patent Application Publication
(10) Pub. No.: US 2016/0263517 A1
(43) Pub. Date: Sep. 15, 2016

(54) ENERGY-SAVING ACIDIC GAS CAPTURE SYSTEM AND METHOD USING CONDENSED WATER

(71) Applicant: KOREA INSTITUTE OF ENERGY RESEARCH, Daejeon (KR)

(72) Inventors: Il Hyun BAEK, Daejeon (KR); Jong Kyun YOU, Daejeon (KR); Ki-Tae PARK, Daejeon (KR)

(21) Appl. No.: 15/030,505

(22) PCT Filed: Dec. 9, 2013
(86) PCT No.: PCT/KR2013/011322

§ 371 Date: Apr. 19, 2016

(30) Foreign Application Priority Data
Nov. 21, 2013 (KR) 10-2013-0142111

(51) Int. Cl. B01D 53/14; B01D 53/18

(52) U.S. Cl. CPC B01D 53/1425; B01D 53/1475; B01D 53/18; B01D 53/1468; B01D 53/1456

(57) ABSTRACT

Provided are a system and method of reducing heat duty that has to be provided to a regenerator for regenerating an absorber in a system for capturing acidic gas such as carbon dioxide, that is, an acidic gas capture system and method capable of reducing energy consumption by utilizing heat generated by the acidic gas capture system itself. The system and method reduce a cooling capacity of a condenser by exchanging heat between condensed water of a low temperature generated by the capture system and processed gas of a high temperature to preheat the condensed water, or reduce a reboiler heat duty by inflowing the condensed water of a low temperature to a regeneration heat after being preheated. In addition, the condensed water of the low temperature may be selectively used to cool down a scrubber located at an upper portion of the absorber or a dilute solution.

### TECHNICAL FIELD

The inventive concept relates to an acidic gas capture system, and more particularly, to a system and method of saving energy by using condensed water that is condensed by a condenser in a carbon dioxide emission system.

### BACKGROUND TECHNOLOGY

As usage of fossil fuel has increased, the concentration of acidic gas such as carbon dioxide (CO₂), methane (CH₄), hydrogen sulfide (H₂S), carbonyl sulfide (COS), etc. in the air increases, thereby causing global warming problem. In particular, various suggestions for reducing carbon dioxide in the air have been actively discussed worldwide since the Rio de Janeiro environment conference held in 1992.

Among acidic gas treatment technologies, a carbon dioxide capture and storage (CCS) technology isolates carbon dioxide from the air, wherein the carbon dioxide is discharged in large quantities from power plants, steel plants, cement plants, etc. in which fossil fuels are used.

A carbon dioxide capturing in the CCS technology is a core technology that consumes about 70% to about 80% of overall cost, and is largely classified as post-combustion technology, pre-combustion technology, and oxy-fuel combustion technology (“Carbon Dioxide Capture and Storage Technology”, Sangdo Park, Physics and High Technology, June 2009).

Post-combustion technology eliminates carbon dioxide (CO₂) that is discharged during combustion of fossil fuel by absorbing or reacting carbon dioxide with various solvents. Pre-combustion technology isolates carbon dioxide before combustion, that is, performs pre-treatment of fossil fuel such as coal into CO₂ and hydrogen via gasification, and then, isolates carbon dioxide (CO₂) from CO₂/H₂ mixture gas or combusts the mixture gas to capture carbon dioxide (CO₂) in the air. In addition, oxy-fuel combustion technology combusts fossil fuel only with oxygen, instead of the air, in order to easily capture carbon dioxide (CO₂). From among the above technologies, post-combustion technology is being used most widely since it is easy to be applied to existing carbon dioxide sources.

Post-combustion technology isolates carbon dioxide by absorbing and desorbing carbon dioxide with an absorbent, and focuses on improvement in performance of the absorbent and process improvement. This technology operates as a wet absorption method and a dry absorption method that are commercially available in order to supply carbon dioxide in such fields of urea fertilizer production, automatic welding, carbonated drinks, etc., and the wet absorption method is high in efficiency.

A representative process of the wet absorption method is a capture process using amine-based absorbent. Although this process is technically reliable since it has been used in a modification process in petrochemical processes, it is necessary to achieve improvements in performance of the absorbent and processes in order to apply the wet absorption method to a flue gas including various contaminants. The process using the amine-based absorbent is a chemical absorption process using alkanolamine that includes amine and hydroxyl groups on an alkyl group as an absorbent, and is equipped with an absorber that selectively absorbs carbon dioxide from inflow gas, a regenerator (heat regenerator) for regenerating the absorbent that has absorbed carbon dioxide, and other supplementary equipment.

Mono ethanol amine (MEA) that is a most widely used amine-based absorbent has alkaline properties generated due to unshared electrons in amine groups, wherein the alkaline properties cause an acid-base neutralization reaction with carbon dioxide that is acidic in an aqueous solution. In addition, a product generated in the above reaction (carbonate or bicarbonate) may be decompressed at a temperature of about 110° C. to 130° C. to be regenerated. Amines used as the absorbent are different from each other in absorption capability of carbon dioxide and absorption rate according to structural characteristics thereof.

A regeneration process is performed at a temperature of about 110° C. to about 130° C., whereas a carbon dioxide absorption process is performed at a temperature of about 40° C. to about 50° C., and thus, some of the aqueous solution vaporizes during the regeneration process and is discharged together with carbon dioxide. Accordingly, a cooler for performing a cold condensation of the steam and a preheating technology capable of reducing a reboiler heat duty are necessary. The carbon dioxide absorption process described above is similarly applied to other acidic gas treatment processes.

Korean Registered Patent No. 0983677 discloses a system and method of absorbing and isolating acidic gas, and provides a method of using steam generated in a boiler as a heat source for regenerating an absorbent. However, the above method has a limitation, that is, the generated steam is only used for regenerating the absorbent.

Therefore, it is necessary to develop a technology for reducing energy consumption for heating and cooling in the regeneration processes.

### Prior Art Documents

[Patent Document]

(Patent Document 1) (0001) Korean Registered Patent No. 0983677

[Non-patent Document]

(Non-patent Document 1) (0001) Carbon Dioxide Capture and Storage Technology, Sangdo Park, Physics and High Technology, June 2009

### DETAILED DESCRIPTION OF THE INVENTIVE CONCEPT

### Technical Problem

The inventive concept provides an acidic gas capture system and method capable of reducing energy consumption by using condensed water generating in the acidic gas capture system itself in thermal exchange of the acidic gas capture system.

### Technical Problem

To address the above problems of the prior art, the present inventors found that energy efficiency may be maximized by cooling or preheating exhaust gas, a scrubber, an absorbent solution, and a dilute solution in a system of the present inventive concept, by using condensed water that is obtained by a condenser through a cold condensation of processed gas discharged from a regenerator, and consequentially has completed the present inventive concept.

According to an aspect of the inventive concept, there is provided an acidic gas capture system for saving energy by utilizing condensed water, including an absorber that absorbs acidic gas by using an absorbent, and a regenerator that separates processed gas from the absorbent, wherein the capture system includes: an exhaust gas supply line supplying exhaust gas containing acidic gas to the absorber via a first heat exchanger and a water separator; an absorbent supply line supplying the absorbent that has absorbed the acidic gas in the absorber to the regenerator via a second heat exchanger; a processed gas line supplying processed gas discharged from the regenerator to a condenser via a third heat exchanger; and a condensed water supply line utilizing condensed water that is generated through the condenser, wherein the condensed water supply line includes: a supply line for supplying the condensed water to a fourth heat exchanger for exchanging heat with a dilute solution; a supply line for supplying the condensed water that has exchanged the heat in the fourth heat exchanger to a fifth heat exchanger for recovering heat from the processed gas discharged from the regenerator; and a line for supplying the condensed water that has passed through the fifth heat exchanger to an upper portion of the regenerator.

According to an aspect of the inventive concept, there is provided an acidic gas capture system for saving energy by utilizing condensed water, including an absorber that absorbs acidic gas by using an absorbent, and a regenerator that separates processed gas from the absorbent, wherein the capture system includes: an exhaust gas supply line supplying exhaust gas containing acidic gas to the absorber via a first heat exchanger and a water separator; an absorbent supply line supplying the absorbent that has absorbed the acidic gas in the absorber to the regenerator via a second heat exchanger; a processed gas line supplying processed gas discharged from the regenerator to a condenser via a third heat exchanger; and a condensed water supply line utilizing condensed water that is generated through the condenser, wherein the condensed water supply line includes: a supply line for supplying the condensed water to a sixth heat exchanger to use the condensed water as cooling water of a scrubber; a supply line for supplying the condensed water that has exchanged heat in the sixth heat exchanger to a fifth heat exchanger for recovering heat from processed gas discharged from the regenerator; and a line for supplying the condensed water that has passed through the fifth heat exchanger to an upper portion of the regenerator.

According to an aspect of the inventive concept, there is provided an acidic gas capture system for saving energy by utilizing condensed water, including an absorber that absorbs acidic gas by using an absorbent, and a regenerator that separates processed gas from the absorbent, wherein the capture system includes: an exhaust gas supply line supplying exhaust gas containing acidic gas to the absorber via a first heat exchanger and a water separator; an absorbent supply line supplying the absorbent that has absorbed the acidic gas in the absorber to the regenerator via a second heat exchanger; a processed gas line supplying processed gas discharged from the regenerator to a condenser via a third heat exchanger; and a condensed water supply line utilizing condensed water that is generated through the condenser, wherein the condensed water supply line includes: a supply line for supplying the condensed water to a sixth heat exchanger to exchange heat with exhaust gas of the absorber; and a line for directly supplying the condensed water that has exchanged heat through the sixth heat exchanger to an absorbent solution that absorbs acidic gas and is discharged from the absorber to recover heat from the absorbent solution.

According to an aspect of the inventive concept, there is provided an acidic gas capture system for saving energy by utilizing condensed water, including an absorber that absorbs acidic gas by using an absorbent, and a regenerator that separates processed gas from the absorbent, wherein the capture system includes: an exhaust gas supply line supplying exhaust gas containing acidic gas to the absorber via a first heat exchanger and a water separator; an absorbent supply line supplying the absorbent that has absorbed the acidic gas in the absorber to the regenerator via a second heat exchanger; a processed gas line supplying processed gas discharged from the regenerator to a condenser via a third heat exchanger; and a condensed water supply line utilizing condensed water that is generated through the condenser, wherein the condensed water supply line includes: a supply line for supplying the condensed water simultaneously to a scrubber and a seventh heat exchanger to use the condensed water as cooling water for the scrubber and a dilute solution; and a line for supplying the condensed water that has passed through the scrubber or the seventh heat exchanger to an upper portion of the regenerator.

The supply line for supplying the condensed water to the scrubber and the seventh heat exchanger may further include a valve for selectively adjusting a flow rate and a temperature of the condensed water to control circulation of the condensed water.

The condenser may operate at a temperature of 30° C. to 40° C.

The acidic gas may be carbon dioxide (CO₂), methane (CH₄), hydrogen sulfide (H₂S), carbonyl sulfide (COS), or mercaptan (RSH, R=hydrocarbon).

According to an aspect of the inventive concept, there is provided a method of capturing acidic gas using an absorber that absorbs acidic gas by using an absorbent and a regenerator that separates processed gas from the absorbent, the method including: supplying exhaust gas containing acidic gas to the absorber to absorb the acidic gas into the absorbent; supplying the absorbent that has absorbed the acidic gas and discharged from the absorber to the regenerator so as to separate the acidic gas from the absorbent; supplying processed gas discharged from the regenerator to a condenser to separate condensed water from the processed gas; and supplying the condensed water generated through the condenser to a condensed water supply line, wherein the supplying of the condensed water includes: supplying the condensed water to a fourth heat exchanger to recover heat from a dilute solution; supplying the condensed water that has recovered heat from the dilute solution to a fifth heat exchanger to recover heat from the processed gas; and supplying the condensed water that has recovered heat from the processed gas to an upper portion of the regenerator.

According to an aspect of the inventive concept, there is provided a method of capturing acidic gas using an absorber that absorbs acidic gas by using an absorbent and a regenerator that separates processed gas from the absorbent, the method including: supplying exhaust gas containing the acidic gas to the absorber to absorb the acidic gas into the absorbent; supplying the absorbent that has absorbed the acidic gas and discharged from the absorber to the regenerator to separate the acidic gas from the absorbent; supplying the processed gas discharged from the regenerator to a condenser to separate condensed water from the processed gas; and supplying the condensed water generated through the condenser to a condensed water supply line that utilizes the condensed water, wherein the supplying of the condensed water includes: supplying the condensed water to a scrubber to cool down the scrubber; supplying the condensed water that has exchanged heat with the scrubber to a fifth heat exchanger to recover heat from the processed gas; and supplying the condensed water that has recovered the heat from the processed gas to an upper portion of the regenerator.

According to an aspect of the inventive concept, there is provided a method of capturing acidic gas using an absorber that absorbs acidic gas by using an absorbent and a regenerator that separates processed gas from the absorbent, the method including: supplying exhaust gas containing acidic gas to the absorber to absorb the acidic gas into an absorbent; supplying the absorbent that has absorbed the acidic gas and is discharged from the absorber to the regenerator to separate the acidic gas from the absorbent; supplying processed gas discharged from the regenerator to a condenser to separate condensed water from the processed gas; and supplying the condensed water generated through the condenser to a condensed water supply line that utilizes the condensed water, wherein the supplying of the condensed water includes: supplying the condensed water to a sixth thermal exchanger located on an upper portion of the absorber to recover heat from the exhaust gas discharged from the absorber; and directly injecting the condensed water that has recovered the heat into an absorbent solution that has absorbed the acidic gas in the absorber.

According to an aspect of the inventive concept, there is provided a method of capturing acidic gas using an absorber that absorbs acidic gas by using an absorbent and a regenerator that separates processed gas from the absorbent, the method including: supplying exhaust gas containing the acidic gas to the absorber to absorb the acidic gas into an absorbent; supplying the absorbent that has absorbed the acidic gas and is discharged from the absorber to the regenerator to separate the acidic gas from the absorbent; supplying processed gas discharged from the regenerator to a condenser to separate condensed water from the processed gas; and supplying the condensed water generated through the condenser to a condensed water supply line that utilizes the condensed water, wherein the supplying of the condensed water includes: supplying the condensed water to a scrubber and a dilute solution to use the condensed water as cooling water for the scrubber and the dilute solution; supplying the condensed water that has recovered heat from the scrubber and the dilute solution to a fifth each exchanger to recover heat from the processed gas; and supplying the condensed water that has recovered the heat from the processed gas to an upper portion of the regenerator.

The condenser may operate at a temperature of 30° C. to 40° C.

The acidic gas may be carbon dioxide (CO₂), methane (CH₄), hydrogen sulfide (H₂S), carbonyl sulfide (COS), or mercaptan (RSH, R=hydrocarbon).

### Advantageous Effects

According to a system and method of the present inventive concept, condensed water of a low temperature exchanges heat with processed gas of a high temperature so as to be preheated, and is introduced into a regenerator so as to reduce a reboiler heat duty. Also, the condensed water of the low temperature may be selectively used for cooling down a scrubber or a dilute solution.

### DESCRIPTION OF THE DRAWINGS

FIG. 1 is a diagram of an acidic gas separating and collecting system according to a prior art;

FIG. 2 is a diagram of an acidic gas capture system according to an embodiment of the inventive concept;

FIG. 3 is a diagram of an acidic gas capture system according to another embodiment of the inventive concept;

FIG. 4 is a diagram of an acidic gas capture system according to another embodiment of the inventive concept;

FIG. 5A is a diagram of an acidic gas capture system according to another embodiment of the inventive concept; and

FIG. 5B is a diagram showing a part of FIG. 5A in more detail.

### EMBODIMENTS OF THE INVENTIVE CONCEPT

Hereinafter, an acidic gas separating and collection system and method according to the inventive concept will be described below with reference to accompanying drawings.

Before describing the present invention in detail, terms or words used in the present specification and claims should not be limited to normal or lexical meanings. Therefore, embodiments recited in the present specification and elements illustrated in accompanying drawings are embodiments, but do not represent all technical spirit and scope of the present invention, and thus, may be substituted or replaced with other components or equivalents.

Here, in the drawings illustrating embodiments of the present invention, like numbers refer to like elements throughout, and detailed description of the same or like elements are not repeated. In the present inventive concept, lines transferring absorbent, processed gas, or condensed water that exchange heat with one another in a heat exchanger are described as “intersecting” with one another. That is, two of these fluid transfer lines intersect with each other in a heat exchanger to exchange heat with each other.

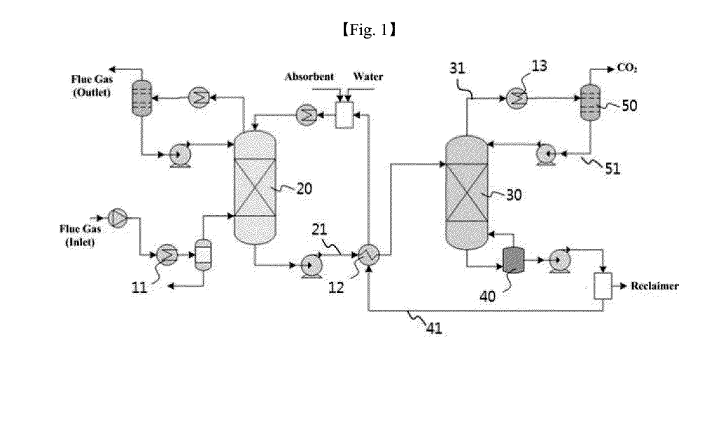

FIG. 1 is a diagram of an acidic gas capture system according to the prior art. Exhaust gas containing acidic gas such as carbon dioxide is supplied to an absorber 20, in which a filling material having a large surface area so as to allow gas and liquid to contact sufficiently is filled, so as to contact an absorbent in a solution state sprayed from above the absorber under an atmospheric condition. The above contact is processed at a temperature range of about 40° C. to about 50° C. so that the acidic gas such as carbon dioxide in the exhaust gas is absorbed by the absorbent solution.

The absorbent discharged from the absorber, that is, the absorbent in which the acidic gas containing carbon dioxide is absorbed, is transferred to a regenerator 30 and is heated at a temperature of about 120° C. After that, processed gas isolated from the absorbent is discharged through an upper portion of the regenerator, and regenerated absorbent is supplied back to the absorber via a reboiler 40 through a circulation process. The processed gas discharged from the regenerator is supplied to a condenser 50 via a processed gas discharge line 31 so that the condenser 50 condenses the processed gas into water and remaining steam and acidic gas such as carbon dioxide are obtained as final products. The condensed water is re-circulated back into the regenerator via a condensed water supply line 51. Such re-circulation may improve a separating efficiency of the regenerator, but becomes a factor of increasing a reboiler heat duty since the condensed water of a low temperature is supplied. The regenerated absorbent is transferred along an absorbent recirculation line to preheat the absorbent that absorbs the acidic gas and is transferred to the regenerator via a second heat exchanger 12, and is supplied back to the absorber in order to newly absorb acidic gas. An absorbent supply line 41 for supplying the regenerated absorbent and an absorbent supply line 21 for supplying the absorbent that absorbs acidic gas in the absorber intersect with each other in the second heat exchanger.

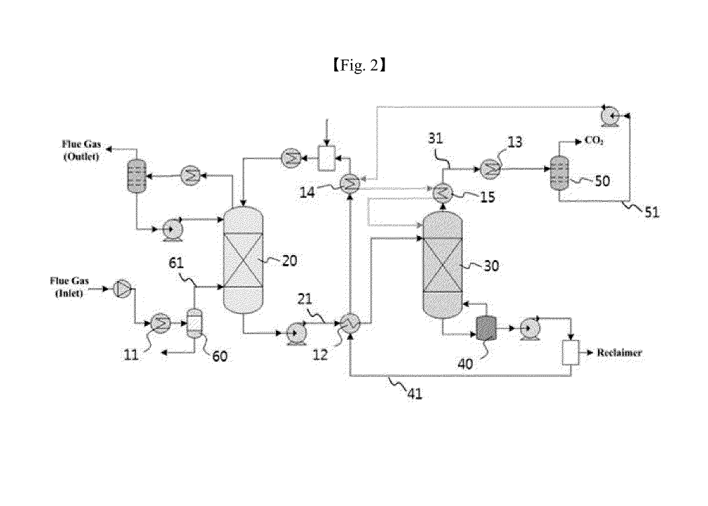

FIG. 2 is a diagram of an acidic gas capture system according to an embodiment of the inventive concept. The acidic gas capture system include an absorber 20 that absorbs acidic gas by using an absorbent, and a regenerator 30 that isolates processed gas from the absorbent. The capture system includes an exhaust gas supply line 61 that supplies exhaust gas containing acidic gas via the first heat exchanger 11 and a water separator 60; an absorbent supply line 21 supplying the absorbent that absorbs the acidic gas in the absorber to the regenerator via the second heat exchanger 12; a processed gas line 31 supplying the processed gas discharged from the regenerator to the condenser 50 via a third heat exchanger 13; and the condensed water supply line 51 utilizing the condensed water generated by the condenser. The condensed water supply line includes a supply line for supplying the condensed water toward a fourth heat exchanger 14 for exchanging heat between the condensed water and a dilute solution; a supply line for supplying the condensed water that has exchanged heat in the fourth heat exchanger toward a fifth heat exchanger 15 for recovering heat from the processed gas discharged from the regenerator; and a line for supplying the condensed water that has passed through the fifth heat exchanger toward an upper portion of the regenerator.

In the acidic gas capture system, the absorbent that has absorbed the acidic gas is supplied to the regenerator, and then, the regenerator removes the acidic gas from the absorbent and regenerates an amine solution (absorbent), that is, the dilute solution. The regenerated absorbent is supplied back to the absorber via the reboiler in order to absorb the acidic gas again. The processed gas discharged from the regenerated column passes through the condenser so that the condensed water is generated and the steam that is not condensed and the acidic gas are obtained as final products. In the present inventive concept, the condensed water is supplied through the condensed water supply line in order to be utilized as cooling water. The condensed water cools down the dilute solution by exchanging heat with the dilute solution, and the condensed water that has recovered the heat is supplied to the fifth heat exchanger to exchange heat with the processed gas of high temperature (e.g., 90° C. to 100° C.) discharged from the regenerator and then is injected to the upper portion of the regenerator. Inflow of cold condensed water to the regenerator as in the prior art becomes a factor of increasing the reboiler heat duty of the reboiler 40. Therefore, the acidic gas capture system illustrated with reference to FIG. 2 may reduce the reboiler heat duty because cold condensed water is not injected to the regenerator. Also, since the processed gas is cooled down, cooling-load of the condenser located at the upper portion of the regenerator may be reduced.

According to an embodiment of the inventive concept, the condenser operates at a temperature of about 30° C. to about 40° C. In addition, acidic gas may be selected from carbon dioxide (CO₂), methane (CH₄), hydrogen sulfide (H₂S), carbonyl sulfide (COS), and mercaptan (RSH, R=hydrocarbon), but is not limited thereto.

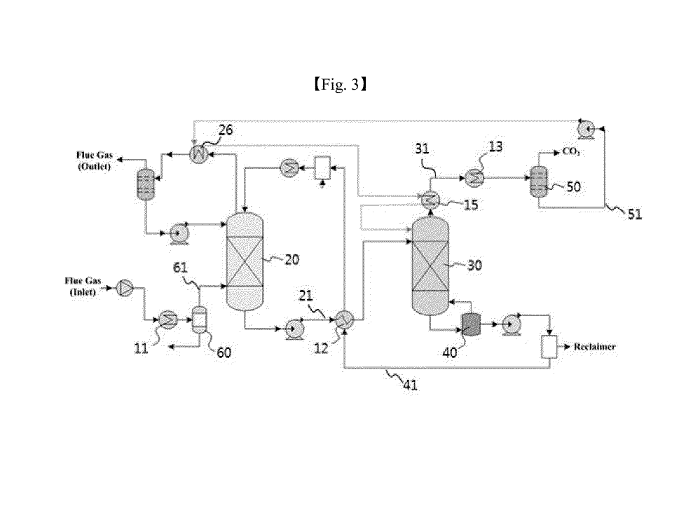

FIG. 3 is a diagram of an acidic gas capture system according to another embodiment of the inventive concept. The acidic gas capture system includes the absorber 20 that absorbs acidic gas by using an absorbent, and the regenerator 30 that separates processed gas from the absorbent. The capture system includes the exhaust gas supply line 61 that supplies exhaust gas containing acidic gas toward the absorber via the first heat exchanger 11 and the water separator 60; the absorbent supply line 21 supplying the absorbent that absorbs the acidic gas in the absorber to the regenerator via the second heat exchanger 12; the processed gas line 31 supplying the processed gas discharged from the regenerator to the condenser 50 via a third heat exchanger 13; and the condensed water supply line 51 utilizing the condensed water generated by the condenser. The condensed water supply line includes a supply line for supplying the condensed water toward a sixth heat exchanger 16 to be used as cooling water of a scrubber 26; a supply line for supplying the condensed water that has exchanged heat in the sixth heat exchanger toward the fifth heat exchanger 15 for recovering heat from the processed gas discharged from the regenerator; and a line for supplying the condensed water that has passed through the fifth heat exchanger toward an upper portion of the regenerator.

When the absorber has a water washing portion for collecting amine on an upper portion thereof, the exhaust gas discharged from the absorber has to be cooled down first in order to scrub impurities existing in the exhaust gas. Therefore, the condensed water may be used as cooling water of the scrubber for cooling down the exhaust gas discharged from the absorber. The condensed water used as the cooling water of the scrubber is supplied to the fifth heat exchanger for recovering heat by exchanging heat with the processed gas generated in the regenerator, and then, is injected to the upper portion of the regenerator. Inflow of cold condensed water as in the prior art becomes a factor of increasing the reboiler heat duty of the reboiler 40. Therefore, the acid gas capture system illustrated with reference to FIG. 3 may reduce the reboiler heat duty because the cold condensed water is not injected to the regenerator. Also, since the processed gas is cooled down, cooling-load of the condenser located at the upper portion of the regenerator may be reduced.

According to an embodiment of the inventive concept, the condenser operates at a temperature of about 30° C. to about 40° C. In addition, acidic gas may be selected from carbon dioxide (CO₂), methane (CH₄), hydrogen sulfide (H₂S), carbonyl sulfide (COS), and mercaptan (RSH, R=hydrocarbon), but is not limited thereto.

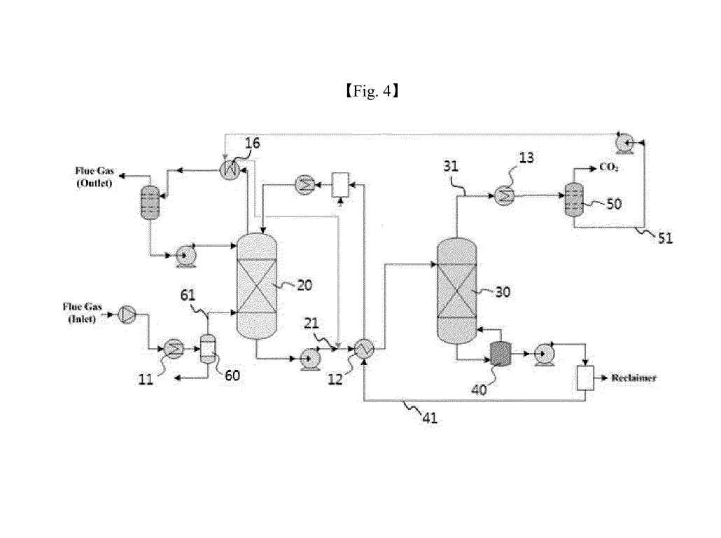

FIG. 4 is a diagram of an acidic gas capture system according to another embodiment of the inventive concept. The acidic gas capture system includes the absorber 20 that absorbs acidic gas by using an absorbent, and the regenerator 30 that separates processed gas from the absorber. The capture system includes the exhaust gas supply line 61 that supplies exhaust gas containing acidic gas toward the absorber via the first heat exchanger 11 and the water separator 60; the absorbent supply line 21 supplying the absorbent that absorbs the acidic gas in the absorber to the regenerator via the second heat exchanger 12; the processed gas line 31 supplying the processed gas discharged from the regenerator to the condenser 50 via the third heat exchanger 13; and the condensed water supply line 51 utilizing the condensed water generated by the condenser. The condensed water supply line includes a supply line for supplying the condensed water toward the sixth heat exchanger 16 for exchanging heat with the exhaust gas discharged from the absorber; and a line for supplying the condensed water that has exchanged the heat in the sixth heat exchanger directly to the acidic gas absorbent solution discharged from the absorber for recovering heat from the absorbent solution that has absorbed the acidic gas.

The condensed water cools down processed exhaust gas discharged from the absorber in the sixth heat exchanger, and after that, the condensed water that has recovered heat is directly injected into the absorbent solution that absorbs the acidic gas and is discharged from the absorber. The absorbent solution that is preheated by the condensed water is preheated to a high temperature (100° C.) while intersecting with the dilute solution (100° C. to 120° C.) that is regenerated by the second heat exchanger, and then, is injected to the regenerator.

According to an embodiment of the inventive concept, the condenser operates at a temperature of about 30° C. to about 40° C. In addition, acidic gas may be selected from carbon dioxide (CO₂), methane (CH₄), hydrogen sulfide (H₂S), carbonyl sulfide (COS), and mercaptan (RSH, R=hydrocarbon), but is not limited thereto.

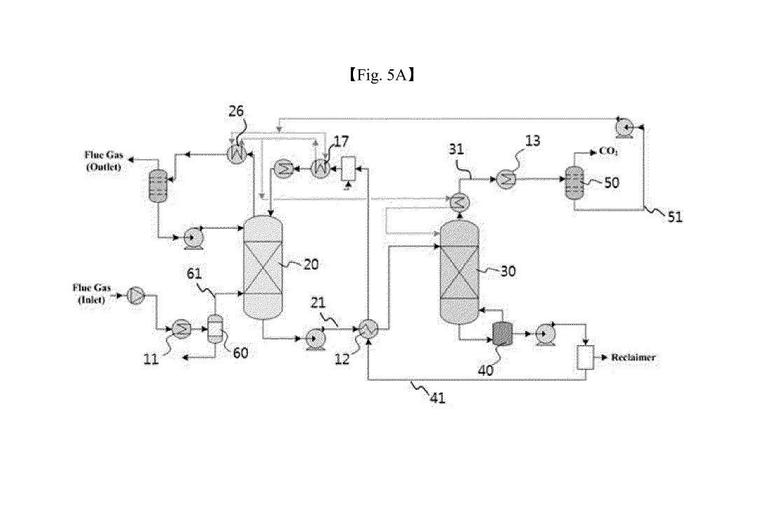

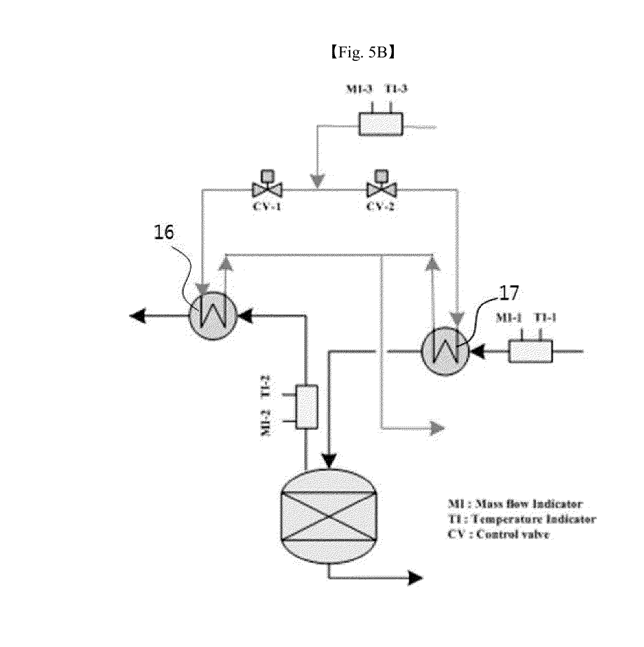

FIG. 5A is a diagram of an acidic gas capture system according to an embodiment of the inventive concept. The acidic gas capture system includes the absorber 20 that absorbs acidic gas by using an absorbent, and the regenerator 30 that separates processed gas from the absorbent. The capture system includes the exhaust gas supply line 61 that supplies exhaust gas containing acidic gas toward the absorber via the first heat exchanger 11 and the water separator 60; the absorbent supply line 21 supplying the absorbent that absorbs the acidic gas in the absorber to the regenerator via the second heat exchanger 12; the processed gas line 31 supplying the processed gas discharged from the regenerator to the condenser 50 via the third heat exchanger 13; and the condensed water supply line utilizing the condensed water generated by the condenser. The condensed water supply line includes a supply line for supplying the condensed water simultaneously toward the scrubber and a seventh heat exchanger 17 in order to use the condensed water as cooling water for the scrubber 26 and the dilute solution; and a line for supplying the condensed water that has passed through the scrubber or the seventh heat exchanger to the upper portion of the regenerator.

When the absorber has a water washing portion for collecting amine on an upper portion thereof, the exhaust gas discharged from the absorber has to be cooled down first in order to scrub impurities existing in the exhaust gas. Therefore, the condensed water may be used as cooling water in the scrubber for cooling down the exhaust gas discharged from the absorber. In the system illustrated with reference to FIG. 5A, the condensed water may be selectively supplied to be used as the cooling water for the scrubber and the dilute solution, and the condensed water that has recovered heat from the scrubber and the dilute solution is supplied to the fifth heat exchanger so as to further recover heat by exchanging heat with the processed gas generated in the regenerator and to be injected to the upper portion of the regenerator. Inflow of cold condensed water as in the prior art becomes a factor of increasing the rebuilder heat duty of the reboiler. Therefore, the acidic gas capture system of FIG. 5A may reduce the reboiler heat duty because cold condensed water is not injected to the regenerator. Also, by cooling down the processed gas, cooling-load of the condenser located at the upper portion of the regenerator may be reduced. FIG. 5B is a diagram of the scrubber and the seventh heat exchanger located on the upper portion of the absorber in the system of FIG. 5A in detail. A flow rate and a temperature at each of supply lines toward the scrubber and the seventh heat exchanger are measured, and after that, the scrubber or the dilute solution may be selectively cooled down by adjusting valves. That is, after measuring a flow rate and a temperature of the dilute solution (Mass flow Indicator (MI)-1, Temperature Indicator (TI)-1), a flow rate and a temperature of the exhaust gas (MI-2, TI-2), and a flow rate and a temperature of the condensed water (MI-3, TI-3), circulation of the condensed water may be adjusted by opening/closing automatic control valves CV-1 and CV-2.

According to an embodiment of the inventive concept, the condenser operates at a temperature of about 30° C. to about 40° C. In addition, acidic gas may be selected from carbon dioxide (CO₂), methane (CH₄), hydrogen sulfide (H₂S), carbonyl sulfide (COS), and mercaptan (RSH, R=hydrocarbon), but is not limited thereto.

According to an aspect of the inventive concept, a method of capturing acidic gas using an absorber that absorbs acidic gas by using an absorbent and a regenerator that separates processed gas from the absorbent, the method includes: supplying exhaust gas containing acidic gas to the absorber to absorb the acidic gas into the absorbent; supplying the absorbent that has absorbed the acidic gas and discharged from the absorber to the regenerator so as to separate the acidic gas from the absorbent; supplying processed gas discharged from the regenerator to a condenser to separate condensed water from the processed gas; and supplying the condensed water generated through the condenser to a condensed water supply line, wherein the supplying of the condensed water includes: supplying the condensed water to a fourth heat exchanger to recover heat from a dilute solution; supplying the condensed water that has recovered heat from the dilute solution to a fifth heat exchanger to recover heat from the processed gas; and supplying the condensed water that has recovered heat from the processed gas to an upper portion of the regenerator.

According to another aspect of the inventive concept, a method of capturing acidic gas using an absorber that absorbs acidic gas by using an absorbent and a regenerator that separates processed gas from the absorbent, the method includes supplying exhaust gas containing the acidic gas to the absorber to absorb the acidic gas into the absorbent; supplying the absorbent that has absorbed the acidic gas and discharged from the absorber to the regenerator to separate the acidic gas from the absorbent; supplying the processed gas discharged from the regenerator to a condenser to separate condensed water from the processed gas; and supplying the condensed water generated through the condenser to a condensed water supply line that utilizes the condensed water, wherein the supplying of the condensed water includes: supplying the condensed water to a scrubber to cool down the scrubber; supplying the condensed water that has exchanged heat with the scrubber to a fifth heat exchanger to recover heat from the processed gas; and supplying the condensed water that has recovered the heat from the processed gas to an upper portion of the regenerator.

According to another aspect of the inventive concept, a method of capturing acidic gas using an absorber that absorbs acidic gas by using an absorbent and a regenerator that separates processed gas from the absorbent, the method includes supplying exhaust gas containing acidic gas to the absorber to absorb the acidic gas into an absorbent; supplying the absorbent that has absorbed the acidic gas and is discharged from the absorber to the regenerator to separate the acidic gas from the absorbent; supplying processed gas discharged from the regenerator to a condenser to separate condensed water from the processed gas; and supplying the condensed water generated through the condenser to a condensed water supply line that utilizes the condensed water, wherein the supplying of the condensed water includes supplying the condensed water to a sixth thermal exchanger located on an upper portion of the absorber to recover heat from the exhaust gas discharged from the absorber; and directly injecting the condensed water that has recovered the heat into an absorbent solution that has absorbed the acidic gas in the absorber.

According to another aspect of the inventive concept, a method of capturing acidic gas using an absorber that absorbs acidic gas by using an absorbent and a regenerator that separates processed gas from the absorbent, the method includes supplying exhaust gas containing the acidic gas to the absorber to absorb the acidic gas into an absorbent; supplying the absorbent that has absorbed the acidic gas and is discharged from the absorber to the regenerator to separate the acidic gas from the absorbent; supplying processed gas discharged from the regenerator to a condenser to separate condensed water from the processed gas; and supplying the condensed water generated through the condenser to a condensed water supply line that utilizes the condensed water, wherein the supplying of the condensed water includes supplying the condensed water to a scrubber and a dilute solution to use the condensed water as cooling water for the scrubber and the dilute solution; supplying the condensed water that has recovered heat from the scrubber and the dilute solution to a fifth each exchanger to recover heat from the processed gas; and supplying the condensed water that has recovered the heat from the processed gas to an upper portion of the regenerator.

While this inventive concept has been particularly shown and described with reference to embodiments thereof, it will be understood by those skilled in the art that various changes in form and details may be made therein without departing from the spirit and scope of the inventive concept as defined by the appended claims.

Unless otherwise defined, all technical and scientific terms used herein have the same meaning as commonly understood by one of ordinary skill in the art. The contents of all publications listed herein will be introduced by reference in an embodiment of the present invention.

### LIST OF REFERENCE NUMERALS

11: first heat exchanger
12: second heat exchanger
13: third heat exchanger
14: fourth heat exchanger
15: fifth heat exchanger
16: sixth heat exchanger
17: seventh heat exchanger
20: absorber
21: absorbent supply line
26: scrubber
30: regenerator
31: processed gas line
40: reboiler
41: regenerated absorbent supply line
50: condenser
51: condensed water supply line
60: water separator
61: exhaust gas supply line

1. An acidic gas capture system for saving energy by utilizing a condensed water, equipped with an absorber that absorbs an acidic gas by using an absorbent, and a regenerator that separates a processed gas from the absorbent, the acidic gas capture system comprising:
an exhaust gas supply line supplying an exhaust gas containing an acidic gas to the absorber via a first heat exchanger and a water separator;
an absorbent supply line supplying the absorbent that absorbs the acidic gas in the absorber to the regenerator via a second heat exchanger;
a processed gas line supplying a processed gas discharged from the regenerator to a condenser via a third heat exchanger; and
a condensed water supply line utilizing a condensed water that is generated through the condenser,
wherein the condensed water supply line comprises any one of (1), (2), (3) or (4):
(1) a supply line for supplying the condensed water to a fourth heat exchanger for exchanging heat with a dilute solution; a supply line for supplying the condensed water that has exchanged the heat in the fourth heat exchanger to a fifth heat exchanger for recovering heat from the processed gas discharged from the regenerator; and a line for supplying the condensed water that has passed through the fifth heat exchanger to an upper portion of the regenerator;
(2) a supply line for supplying the condensed water to a sixth heat exchanger to use the condensed water as cooling water of a scrubber; a supply line for supplying the condensed water that has exchanged heat in the sixth heat exchanger to a fifth heat exchanger for recovering heat from processed gas discharged from the regenerator; and a line for supplying the condensed water that has passed through the fifth heat exchanger to an upper portion of the regenerator;
(3) a supply line for supplying the condensed water to a sixth heat exchanger to exchange heat with exhaust gas of the absorber; and a line for directly supplying the condensed water that has exchanged heat through the sixth heat exchanger to an absorbent solution that absorbs acidic gas and is discharged from the absorber to recover heat from the absorbent solution; or
(4) a supply line for supplying the condensed water simultaneously to a scrubber and a seventh heat exchanger to use the condensed water as cooling water for the scrubber and a dilute solution; a line for supplying the condensed water that has passed through the scrubber or the seventh heat exchanger to an upper portion of the regenerator; and a valve for selectively adjusting a flow rate and a temperature of the condensed water to control circulation of the condensed water.

2. (canceled)

3. (canceled)

4. (canceled)

5. (canceled)

6. The acidic gas capture system according to claim 1, wherein the condenser operates at a temperature of 30° C. to 40° C.

7. The acidic gas capture system according to claim 1, wherein the acidic gas is carbon dioxide (CO₂), methane (CH₄), hydrogen sulfide (H₂S), carbonyl sulfide (COS), or mercaptan (RSH, R=hydrocarbon).

8. A method of capturing acidic gas using an acidic gas capture system equipped with an absorber that absorbs acidic gas by using an absorbent and a regenerator that separates processed gas from the absorbent, the method comprising:
supplying exhaust gas containing acidic gas to the absorber to absorb the acidic gas into the absorbent;
supplying the absorbent that has absorbed the acidic gas and discharged from the absorber to the regenerator so as to separate the acidic gas from the absorbent;
supplying processed gas discharged from the regenerator to a condenser to separate condensed water from the processed gas; and
supplying the condensed water generated through the condenser to a condensed water supply line,
wherein the supplying of the condensed water comprises: any one of (1), (2), (3) or (4):
(1) supplying the condensed water to a fourth heat exchanger to recover heat from a dilute solution; supplying the condensed water that has recovered heat from the dilute solution to a fifth heat exchanger to recover heat from the processed gas; and supplying the condensed water that has recovered heat from the processed gas to an upper portion of the regenerator;
(2) supplying the condensed water to a scrubber to cool down the scrubber; supplying the condensed water that has exchanged heat with the scrubber to a fifth heat exchanger to recover heat from the processed gas; and supplying the condensed water that has recovered the heat from the processed gas to an upper portion of the regenerator;
(3) supplying the condensed water to a sixth thermal exchanger located on an upper portion of the absorber to recover heat from the exhaust gas discharged from the absorber; and directly injecting the condensed water that has recovered the heat into an absorbent solution that has absorbed the acidic gas in the absorber; or
(4) supplying the condensed water to a scrubber and a dilute solution to use the condensed water as cooling water for the scrubber and the dilute solution; supplying the condensed water that has recovered heat from the scrubber and the dilute solution to a fifth each exchanger to recover heat from the processed gas; and supplying the condensed water that has recovered the heat from the processed gas to an upper portion of the regenerator.

9. (canceled)

10. (canceled)

11. (canceled)

12. The method according to claim 8, wherein the condenser operates at a temperature of 30° C. to 40° C.

13. The method according to claim 8, wherein the acidic gas is carbon dioxide (CO₂), methane (CH₄), hydrogen sulfide (H₂S), carbonyl sulfide (COS), or mercaptan (RSH, R=hydrocarbon).
